(19) United States
(12) Patent Application Publication
(10) Pub. No.: US 2001/0039764 A1
(43) Pub. Date: Nov. 15, 2001

(54) ADA-COMPLIANT WINDOW

(75) Inventor: RA N. PATTERSON, BELEN, NM (US)

Correspondence Address: PEACOCK MYERS AND ADAMS P C, P O BOX 26927, ALBUQUERQUE, NM, 871256927

(73) Assignee: Jeffrey D. Myers

(21) Appl. No.: 09/045,346

(22) Filed: Mar. 20, 1998

Related U.S. Application Data
(60) Provisional application No. 60/041,024, filed on Mar. 20, 1996.

(51) Int. Cl. E06B 3/32

(52) U.S. Cl. 49/425

(57) ABSTRACT

A horizontal sliding window comprising a glazed section and a screen section and means for opening, closing, locking, and unlocking requiring no more than five pounds of initial force to open, close, lock, and unlock the sections. In the preferred embodiment, the window is reversible before and after installation. The window comprises frame and sash members of aluminum, preferably 6063 T5 aluminum, or vinyl, preferably multi-chambered extruded vinyl. The sections slide on a stainless steel track and use rollers which are adjustable without removing a sash, preferably enclosed ball bearing rollers.

### CROSS-REFERENCE TO RELATED APPLICATIONS

This application claims the benefit of the filing of U.S. Provisional Patent Application Ser. No. 60/041,024, entitled ADA Compliant Window (DSS-4040), filed on Mar. 20, 1997, and the specification thereof is incorporated herein by reference.

### BACKGROUND OF THE INVENTION

The invention relates to a horizontal sliding window to comply with the ABO/ANSI A117.1 1992 4.12 Window and the egress requirements of other applicable codes.

A growing concern in the construction industry has been to meet the construction requirements of the Americans with Disabilities Act (ADA). The present invention meets the ADA window requirements as well as those of the Uniform Building Code (UBC). It takes no more than five pounds of initial force to operate the window, unlock the window, or close the window. The invention provides a sliding screen which is more accessible for emergency ingress or egress, whereas a standard window has a screen that is fixed.

### SUMMARY OF THE INVENTION (DISCLOSURE OF THE INVENTION)

The present invention is of a horizontal sliding window comprising a glazed section and a screen section and means for opening, closing, locking, and unlocking requiring no more than five pounds of initial force to operate, close, lock, and unlock the sections. In the preferred embodiment, the window is reversible before and after installation. The window comprises frame and sash members of aluminum, preferably 6063 T5 aluminum, or vinyl, preferably multi-chambered extruded vinyl. A lock style of tubular construction is provided. The sections slide on a stainless steel track and use rollers which are adjustable without removing a sash, preferably enclosed ball bearing rollers. A nailing fin is provided on jambs and head of the window.

A primary object of the present invention is to provide and ADA-compliant window which takes no more than five pounds of initial force to operate, unlock, or close.

A primary advantage of the present invention is that it provides ADA-compliance with a design that is elegant yet inexpensive.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a horizontal section view of the preferred aluminum embodiment of the window of the invention;

FIGS. 2(a)-(d) are views of the latches of the aluminum embodiment;

FIG. 3 is a vertical section view of the aluminum embodiment;

FIG. 4 is a horizontal section view of the preferred vinyl embodiment of the window of the invention;

FIGS. 5(a)-(d) are views of the latches of the vinyl embodiment; and

FIG. 6 is a vertical section view of the vinyl embodiment.

### DESCRIPTION OF THE PREFERRED EMBODIMENTS (BEST MODES FOR CARRYING OUT THE INVENTION)

The present invention is of a window complying with requirements of the ADA, UBC-EGRESS Codes. The window is preferably of aluminum (most preferably thermally broken aluminum) or reversible vinyl frame and sash members (window sashes can be reversible). Adjustable ball bearing rollers and the locking mechanism allow the window to open and operate freely while also meeting the applicable code requirements. The window rolls horizontally along a track (preferably stainless steel) and has a screen that also rolls horizontally. A nailing fin is preferably provided to be used for either new construction or retrofit into an existing opening.

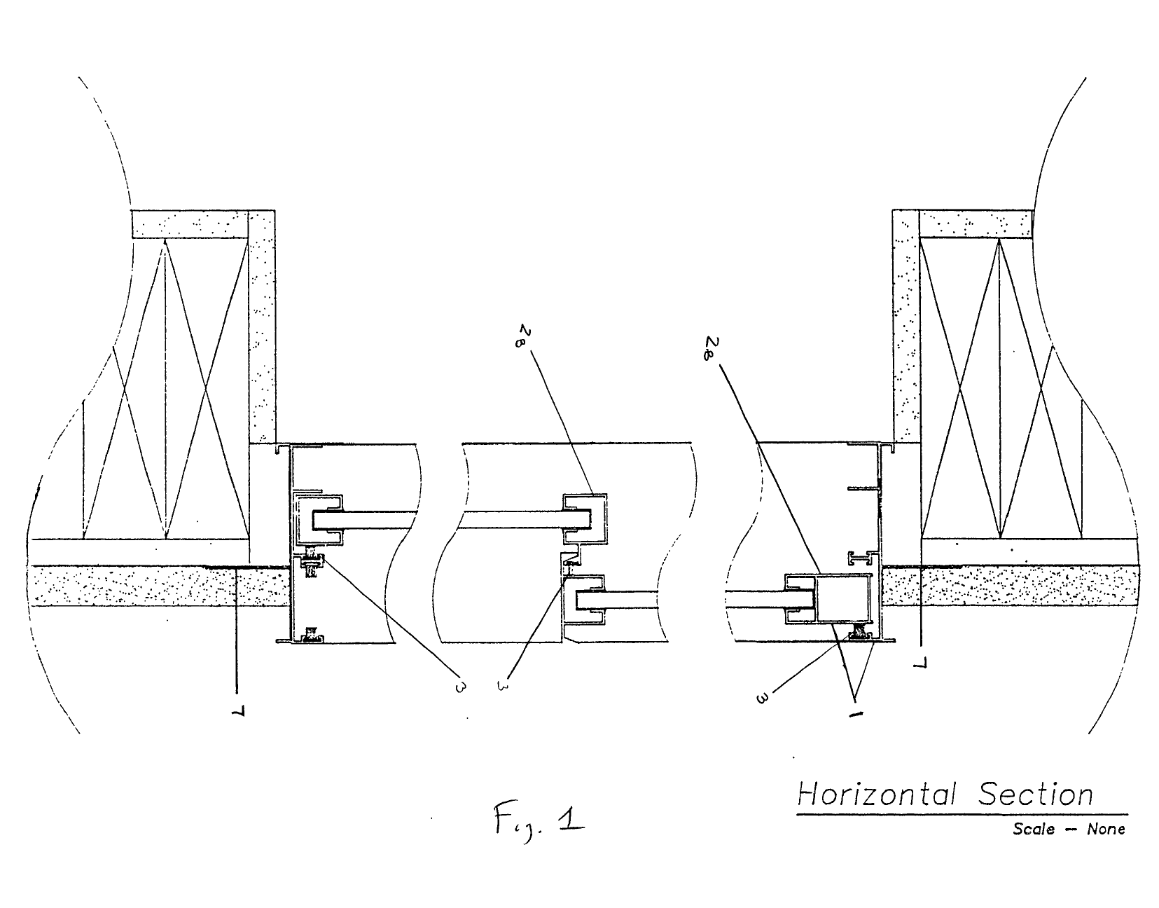

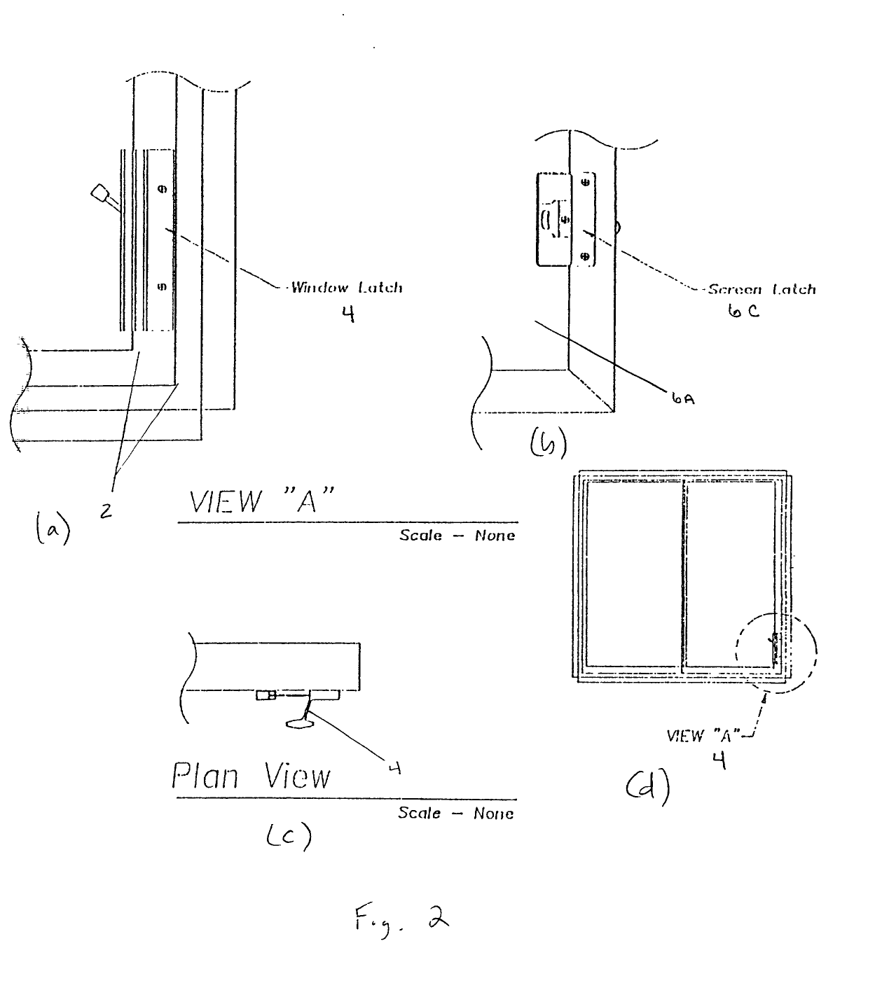

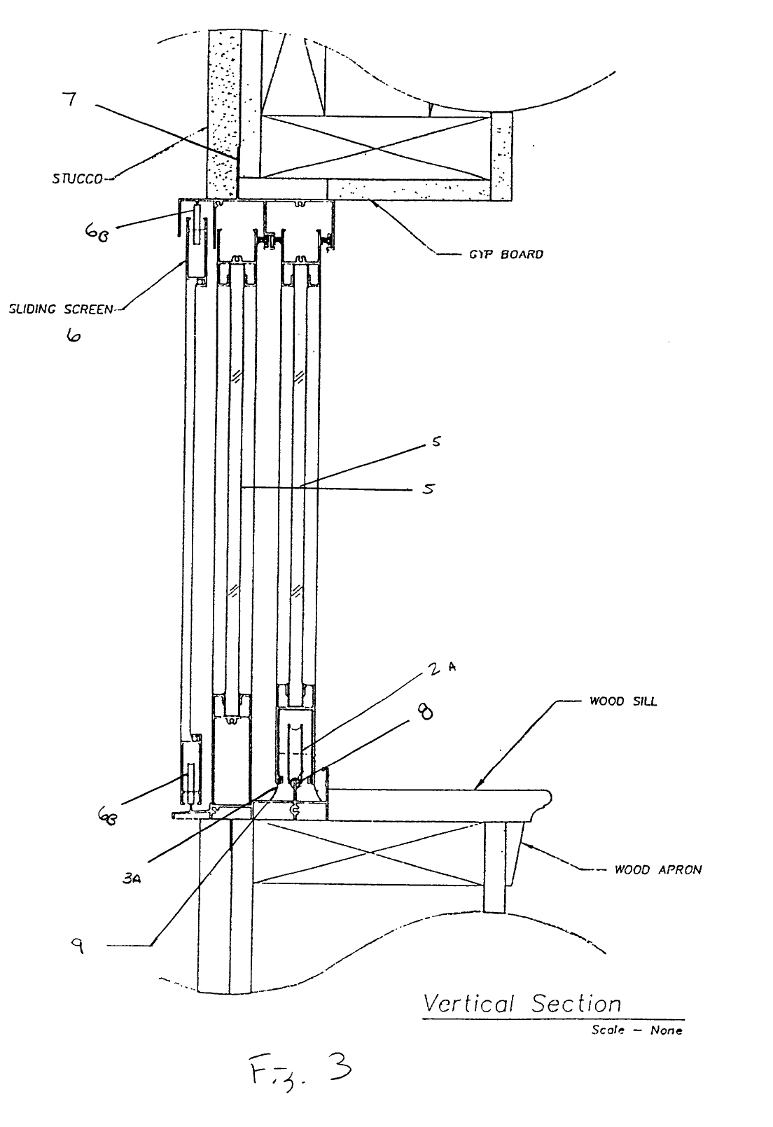

Attention is directed to FIGS. 1-3, which illustrate the preferred aluminum embodiment of the invention. Frame and sash members 1 are of 6063 T5 aluminum alloy. Fasteners, hardware and other accessories are also aluminum, non-magnetic steel, or other non-corrosive materials or material compatible with aluminum or may be of cadmium or zinc plated steel properly treated for corrosion resistance with a stainless steel guide track. Frame and sash members 2 must be accurately cut and joined to make a weathertight joint. The lock stile is preferably of tubular extrusion sections. Moving vents 2a are provided with two adjustable roller assemblies and must be adjustable without removing the moving vent from the frame. Horizontal fixed and moving vent sections 2b are recessed into their vertical members for additional strength, with the moving vent to the interior. The window is reversible either before or after installation with interlocking comers to add stability. Jamb and head 3 are preferably double weather-stripped. Weather-stripping may be rot and mildew proof poly-pile. Bottom rail 3a is preferably double weather-stripped with vinyl. The sliding vent is equipped with an adjustable locking device 4 which will not permit the sliding vent to be locked automatically nor permit damage to the lock if the sliding vent is closed when the latch is in the closed position. The keeper is adjustable to meet field conditions. The outside pull and latch is adaptable for a cylinder lock when specified. Cylinders when specified are preferably five pin type with provisions for master keying. The locking latch is preferably the extended type for easy access for ADA capability. All vent members 5 are constructed to allow either shop or field glazing with vinyl wrap around glazing material. Screen frames 6 are preferably of hollow extruded 6063 T5 aluminum alloy or of aluminum roll formed section securely joined by comer lock inserts. Screen cloth 6a are preferably 18x16 fiberglass secured by vinyl screen spline. Sliding screens 6b preferably include top and bottom steel rollers, and exterior and interior pulls, latch and vinyl bug seal 6c. The horizontal sliding windows are preferably erected in properly level and plumb openings in accordance with manufacturers' instructions. All caulking is preferably sufficient to accomplish a thoroughly weathertight installation.

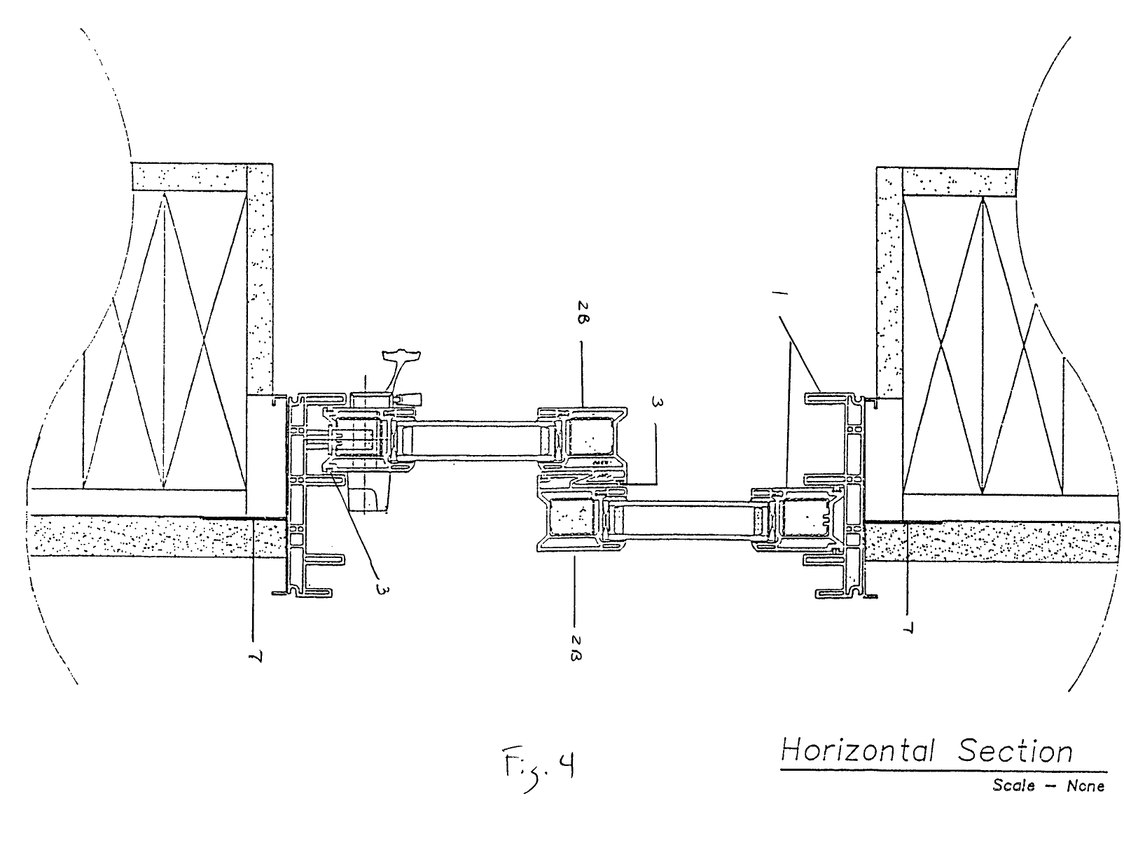

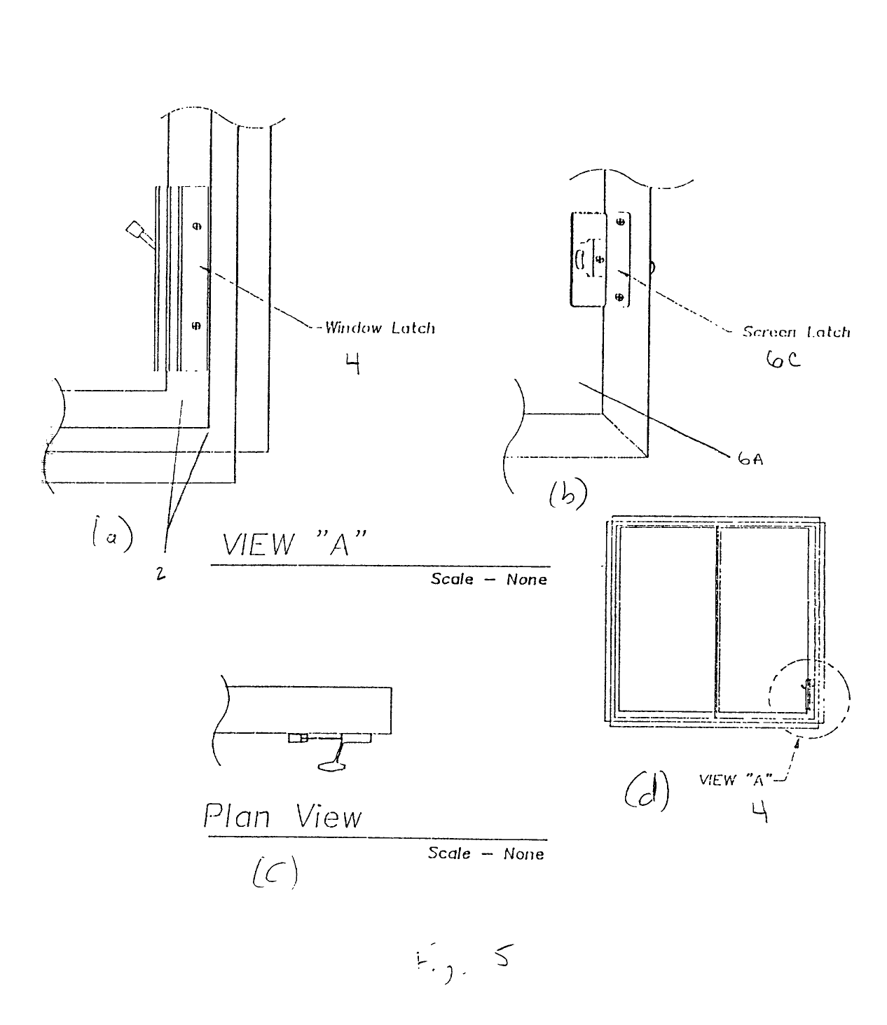

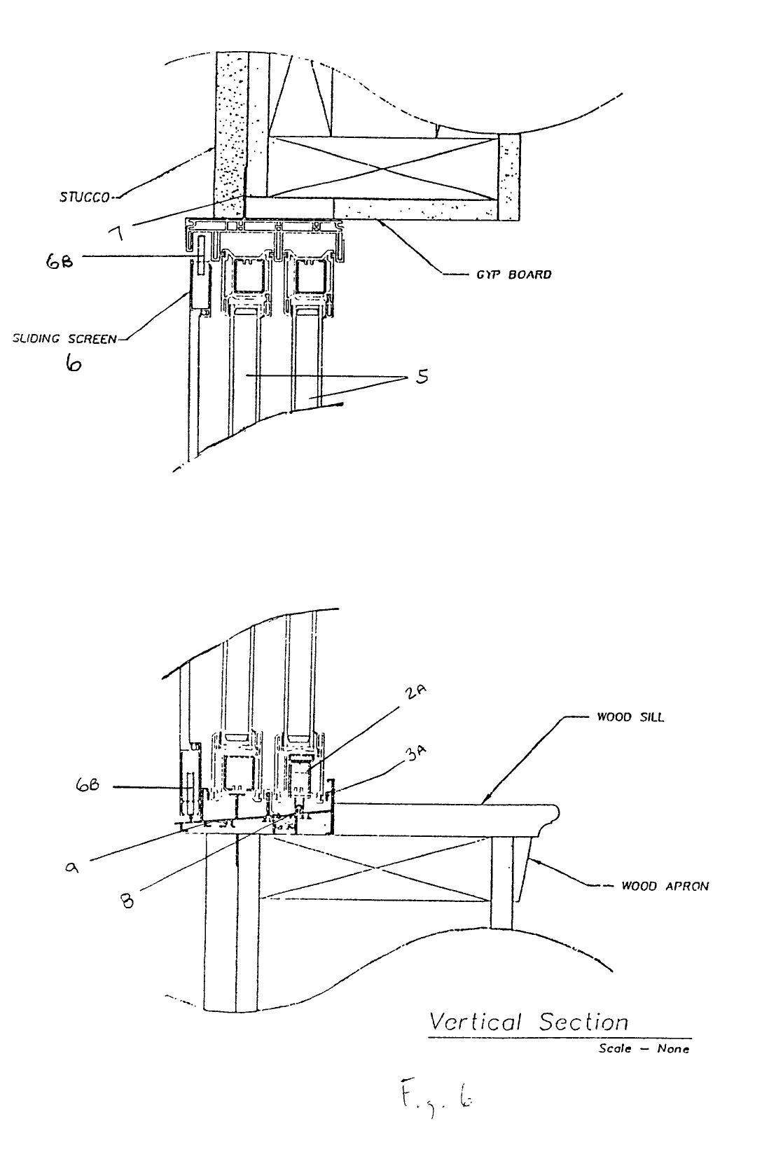

Attention is directed to FIGS. 4-6, which illustrate the preferred vinyl embodiment of the invention. Frame and sash members 1 are preferably of multi-chambered extruded vinyl. Fasteners, hardware and other accessories are preferably aluminum, non-magnetic steel or other non-corrosive materials or material compatible with vinyl or may be of cadmium of zinc plated steel properly treated for corrosion resistance. Frame and sash members are preferably accurately cut and joined to make a weathertight joint 2. The frame preferably has screwed comers. The sash preferably has welded comers. Sashes are preferably steel reinforced. The lock stile is preferably of tubular extrusion sections. Moving vents 2a are preferably provided with two adjustable roller assemblies and must be adjustable without removing the moving vent from the frame. Horizontal fixed and moving vent sections 2b are preferably recessed into their vertical members for additional strength. The window is preferably reversible either before or after installation. Jamb and head 3 are preferably double weather-stripped. Weather-stripping is preferably rot and mildew proof poly-pile. The bottom rail 3 is preferably double weather-stripped with vinyl. The sliding vent is preferably equipped with an adjustable locking device 4 which will not permit the sliding vent to be locked automatically nor permit damage to the lock if sliding vent is closed when latch is in the closed position. The keeper is preferably adjustable to meet field conditions. The outside pull and latch are preferably easily adaptable for cylinder lock when specified. Cylinders when specified are preferably five pin type with provisions for master keying. The locking latch is preferably the extended type for easy access. All vents members 5 are preferably constructed to allow either shop or field glazing with snap in vinyl interior glazing bead. The screen frames 6 are preferably of hollow extruded 6063 T5 aluminum alloy or of aluminum roll formed section securely joined by comer lock inserts. The screen clothes 6a are preferably 18×16 fiberglass secured by vinyl screen spline. Sliding screens 6b preferably include top and bottom steel rollers, and exterior and interior pulls, latch and vinyl bug seal 6c. The horizontal sliding vinyl windows of the invention are preferably erected in properly level and plumb openings in accordance with manufacturers instructions. All caulking is preferably sufficient to accomplish a thoroughly weathertight installation.

The preferred manner of installation follows the following steps:

1. The rough opening should allow 1/2″clearance on top and both sides.

2. Center the window in the opening and install plumb, square, and level. Handle the window by the side jambs, not by the head jamb.

3. When installing, the operable sash should be closed and locked.

4. Fasten the frame securely, without twisting or bowing. If nailing is used to secure the window, put a small bead of caulking behind the nailer fin before installing.

5. Shim the window as necessary to prevent sagging or bowing.

6. Keep the siding material 1/4″from the head frame.

7. In stucco applications, flash the top of the window unit.

8. After completion of trim, brick, stucco, or similar finishing, caulk the exterior perimeter of the window.

The advantageous features of the window of the invention include:

Being completely reversible before or after installation.

Heavy extruded vinyl.

Heavy aluminum extrusions (standard aluminum or thermal break).

Tubular construction on lock stile.

Interlocking comer adds stability.

Moving vent inside slide.

Sliding outside screen.

Quiet and smooth operation.

Window slides on stainless steel track 8.

Rollers adjustable without removing sash.

Double weatherstrip on jamb, top and bottom rails.

Low profile sill for better water runoff 9.

Custom type hardware with ADA latch.

Keyed cylinder lock available.

Simplified installation.

Integral nailing fin 9 on jambs and head.

Enclosed ball bearing rollers for added protection from water and dust.

Poly-pile weatherstripping (denser, longer life, rot and mildew-proof).

Wrap around type glazing in aluminum units.

Interior removable glazing bead in vinyl units.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A horizontal sliding window comprising a glazed section and a screen section and means for opening, closing, locking, and unlocking requiring no more than five pounds of initial force to open, close, lock, and unlock said sections.

2. The window of claim 1 wherein said window is reversible before and after installation.

3. The window of claim 1 wherein said window comprises frame and sash members comprising aluminum.

4. The window of claim 3 wherein said aluminum comprises 6063 T5 aluminum.

5. The window of claim 1 wherein said window comprises frame and sash members comprising vinyl.

6. The window of claim 5 wherein said vinyl comprises multi-chambered extruded vinyl.

7. The window of claim 1 additionally comprising a lock stile of tubular construction.

8. The window of claim 1 wherein said sections slide on a stainless steel track.

9. The window of claim 1 wherein said sections comprise rollers which are adjustable without removing a sash.

10. The window of claim 9 wherein said rollers comprise enclosed ball bearing rollers.

11. The window of claim 1 additionally comprising an integral nailing fin on jambs and head of said window.

12. A horizontal sliding window comprising a glazed section and a screen section and means for opening, closing, locking, and unlocking requiring no more than five pounds of initial force to open, close, lock, and unlock said sections wherein said window is reversible before and after installation.

13. The window of claim 12 wherein said window comprises frame and sash members comprising a material selected from the group consisting of aluminum and vinyl.

14. The window of claim 13 wherein said material is selected from the group consisting of 6063 T5 aluminum and multi-chambered extruded vinyl.

15. The window of claim 12 wherein said sections comprise enclosed ball bearing rollers which are adjustable without removing a sash.

16. A horizontal sliding window comprising a glazed section and a screen section and means for opening, closing, locking, and unlocking requiring no more than five pounds of initial force to open, close, lock, and unlock said sections wherein said window is reversible before and after installation and comprises frame and sash members comprising a material selected from the group consisting of 6063 T5 aluminum and multi-chambered extruded vinyl.

17. The window of claim 16 wherein said sections comprise enclosed ball bearing rollers which are adjustable without removing a sash.

18. A horizontal sliding window comprising a glazed section and a screen section and means for opening, closing, locking, and unlocking requiring no more than five pounds of initial force to open, close, lock, and unlock said sections wherein said window is reversible before and after installation and comprises frame and sash members comprising a material selected from the group consisting of 6063 T5 aluminum and multi-chambered extruded vinyl, and wherein said sections comprise enclosed ball bearing rollers which are adjustable without removing a sash.
